(19) United States
(12) Patent Application Publication
(10) Pub. No.: US 2008/0134333 A1
(43) Pub. Date: Jun. 5, 2008

(54) Detecting exploits in electronic objects

(75) Inventor: Alexander Shipp, Gloucester (GB)

Correspondence Address: NIXON & VANDERHYE, PC, 901 NORTH GLEBE ROAD, 11TH FLOOR, ARLINGTON, VA, 22203, US

(73) Assignee: MessageLabs Limited, Gloucester (GB)

(21) Appl. No.: 11/633,076

(22) Filed: Dec. 4, 2006

(51) Int. Cl. G06F 11/00

(52) U.S. Cl. 726/23

(57) ABSTRACT

A scanning system 1 scans electronic objects for exploits. An object analyser 5 detects objects using various techniques. Some techniques involve detection of a pattern of bytes which is characteristic of a program file of a specific format. Other techniques use statistical fingerprinting.

The present invention relates to the scanning of electronic objects, for example documents, to detect exploits which are malicious code taking advantage of a security flaw in an application program for processing the electronic object. The present invention is particularly concerned with exploits which are unknown to the scanning system or organisation doing the scanning.

Such exploits occur when there are security flaws in the code in an application which processes a type of electronic object. A specially crafted electronic object can incorporate an exploit which causes the application on processing of the document to run divert execution flow from the normal path the application follows and instead run code of the attacker's choice. This code often extracts and runs a program file hidden in the object. Most typically the electronic object is a document which may be rendered by the application program, for example a document rendered by one of the applications in the Microsoft Office suite.

Over the past few years there has been an increasing trend for people to attempt industrial espionage electronically. For example, on the basis of analysis of these attacks from 2004 to 2006, one particular type of attack is extremely common. In this scenario, the attack consists of an e-mail with an attached document, such as a Microsoft Office document, attached to it being sent to a selected victim working for the target organisation. The e-mail uses social engineering to tempt the victim into opening the attachment. The document will contain an exploit which takes advantage of security flaws in the associated application, such as Microsoft Office, such that when the document is opened the attacker can cause arbitrary code to run. Typically this code will extract, decode, create and run an executable program file for example in the PE (Portable Executable) file format which was previously hidden in the document. The victim's PC (personal computer) is now compromised and the attacker can now do what they wish. Other attack scenarios occur, but the above is by far the most common.

This kind of attack is very attractive to the attacker for the following reasons.

(1) Due to the large amount of malware prevalent in email, many organisations now block emails containing the types of attachments most usually used to propagate malware, such as PE executable files, VBS scripts and the like. However, very few organisations block documents because the business-need to pass documents by email is very high, and the likelihood of attack via this vector is perceived to be low from the perspective of the single organisation. Thus it is perceived that the cost to an organisation of blocking documents is high compared to the potential benefit.

(2) Existing scanning systems for detection of malware generally rely on signature-based detection. However the type of attack presently being considered will never be detected by signature-based detection, because the document used is a one-off crafted piece of malware. Signature-based detection relies on the provider of the signature-based system obtaining a sample of a piece of malware, for example from an alert previous victim. The provider can then create a signature which will protect future victims. However, in the type of attack presently being considered, over 50% of cases occur as just one email being sent to one target, and therefore there is no previous victim, alert or otherwise. In most of the other cases where more than one email is sent, the emails are often sent within a period of seconds, or minutes. Since it typically takes a signature-based system provider something of the order of 10 hours or more to create a signature, and then an arbitrary time for their customers to download and apply the signature, this means that it is not likely that the signature will arrive before the email is opened.

(3) For those targets relying on signature based detection, the success of the attack then depends largely on the ability of the attacker to persuade the victim into opening the attachment. History has shown that this is exceedingly likely, even with fairly rudimentary social engineering

(4) Once the victim machine is compromised, it will tend to remain compromised for a long time. The victim never sent the document to their signature-based scanning provider for analysis, and if they have the only copy in existence, the provider will not get a copy to create a signature with. The organisation may therefore remain compromised for weeks, months or years.

Some proactive form of defence against this form of attack is therefore desirable.

If it were possible to identify the security flaws in application program on which the exploits are based, then effective forms of detection of the exploits could be developed. However, in the general case such detection is very difficult or even impossible for several reasons, as follows:
Vendors of the application programs do not publish their source code.
Even if they did, examining the source code to find possible exploits is very difficult and time consuming.
Reverse engineering compiled code to find possible exploits is even more difficult and time consuming.
Even if it is public knowledge that a particular application is currently being exploited, some vendors are very reluctant to publish details on how to detect the exploit, because that knowledge would possibly also allow other people to recreate the exploit, thereby increasing the risk to unprotected users.

As mentioned, most of the attacks of the type under consideration have a common thread in that an executable program file such as a PE file hidden in a document is extracted and executed.

The present invention is based on the appreciation that detection of such hidden program files presents an extremely attractive method of detecting such attacks, because it allows previously unknown exploits to be detected regardless of the nature of the exploit concerned.

As a side benefit, once it has been discovered that the document contains an exploit, further work can then be undertaken to discover just how the exploit works. This can eventually lead to the vendor of the application program concerned discovering the security flaw in their product and fixing it. This will therefore be beneficial to all their customers.

In the following discussion, the term program file is used in a wider sense than normal. Usually, this term is used to executable image saved on some type of storage device, such as a disk. However, to make description of the invention easier and less clumsy, we widen the term to include a contiguous series of bytes, possibly encrypted, inside a larger series of bytes, which if decrypted and considered alone could be interpreted as an executable image. Thus there is no requirement for the “file” to be on some storage device, but could be anywhere where a series of bytes can be analysed, such as computer memory or even in transit on a network.

There are two aspects to the present invention each relating to a different technique for detecting exploits based on the detection of program files hidden in an electronic object.

According to the first aspect of the present invention, there is provided a method of scanning electronic objects for exploits, the method comprising:

scanning the electronic objects to detect a pattern of bytes which is characteristic of a program file of a specific format; and

responsive to detecting such a pattern of bytes in an electronic object, outputting a signal indicating that there is a likelihood of the electronic document containing an exploit.

In accordance with the first aspect of the present invention program files hidden in the electronic objects are detected by scanning the objects for a pattern of bytes which is characteristic of a program file of a specific format. This is based on the principle that it is possible to identify a pattern of bytes which will be characteristic of that format in the sense that it is always or predominantly present in a file of a specific format. Thus detection of the pattern of bytes indicates a high probability of a program file in that format being present in the electronic object. As discussed above this is taken to indicate that there is a likelihood of the electronic document containing an exploit and a signal indicating this is output. Remedial action may then be taken in response to the signal.

The method may be implemented in respect of a plurality of patterns of data in respect of all file formats for program files which are considered likely to pose a risk of being used as an exploit. As discussed above, one type of file format which may be used is the PE format, but other file formats may be used for example the ELF format.

It has been appreciated that attackers sometimes encode the program files. To combat this, the scanning may be performed to detect the pattern of bytes not only in unencoded form but also in a plurality of encoded forms. This allows detection of exploits protected by an encoding which is subject to cryptographic attack. One example of such a type of encoding which may be tackled in this way is XOR-encoding.

A method in accordance with the first aspect of the invention is very effective in finding exploits provided that (a) the relevant file formats for program files can be identified and (b) the exploit is not encoded or is encoded using a type of encoding susceptible to cryptographic attack. However, this method will not find an exploit in which the attacker has used a new format of program file, a new method of encoding or a method of encoding which is not susceptible to cryptographic attack. The second aspect of the present invention allows the detection of exploits in such cases.

According to the second aspect of the present invention, there is provided a method of scanning electronic objects for exploits, the method comprising the following steps performed in respect of individual electronic objects:

analysing the electronic objects to determine whether each electronic object is likely to be of a known type of a set of known types;

responsive to determining that an electronic object is likely to be of a known type:

(a) deriving a distribution, across at least part of the electronic object, of a statistical measure which is a measure of the degree of variation in the data values of the electronic object within a region of the electronic object;

(b) extracting at least one fingerprint in respect of the known type from a database of fingerprints which represent distributions of said statistical measure in respect of the known types of said set of known types of electronic object;

(c) determining whether the derived distribution fails to match the extracted at least one fingerprint; and

(d) responsive to a determination that the derived distribution fails to match the extracted fingerprint, outputting a signal indicating that there is a likelihood of the electronic document containing an exploit.

Thus the second aspect of the present invention using a statistical fingerprinting technique. In particular the fingerprint uses a statistical measure which is a measure of the degree of variation in the data values of the electronic object within a region of the electronic object. The fingerprint represents the distribution of such a statistical measure. Fingerprints for known types of electronic object are derived and stored in a database. During scanning the type of an electronic object is determined, and the distribution of the statistical measure for the electronic object is derived and compared with the fingerprint for an electronic document of that type extracted from the database. If the actual derived distribution does not match the fingerprint for an electronic document of that type, it means the electronic object contains something of an unexpected form and so this is taken to indicate that there is a likelihood of the electronic document containing an exploit and a signal indicating this is output. Remedial action may then be taken in response to the signal.

This technique only works in respect of electronic objects whose type can be determined. Electronic objects whose type cannot be determined are not tested against the fingerprints. To cover such cases, then further according to the present invention there is provided a method of scanning electronic objects for exploits, the method comprising the following steps performed in respect of individual electronic objects:

deriving a distribution, across at least part of the electronic object, of a statistical measure which is a measure of the degree of variation in the data values of the electronic object within a region of the electronic object;

detecting whether the derived distribution, in any part, matches any fingerprint in a database of fingerprints which each represent a distribution of said statistical measure in respect of a program file of a specific format; and

responsive to detecting that the derived distribution matches a fingerprint in the database, outputting a signal indicating that there is a likelihood of the electronic document containing an exploit.

Again a statistical fingerprinting technique is used in which the fingerprint uses a statistical measure which is a measure of the degree of variation in the data values of the electronic object within a region of the electronic object. However in this case, fingerprints in respect of a program file of specific formats are derived and stored in a database. During scanning, the distribution of the statistical measure for the electronic object is derived and compared with all the fingerprints for program files of specific formats stored in the database. Thus detection of a match between the derived distribution and a fingerprint means that a program file in that format is present in the electronic object. As discussed above this is taken to indicate that there is a likelihood of the electronic document containing an exploit and a signal indicating this is output. Remedial action may then be taken in response to the signal.

Further according to the present invention there are provided scanning systems which implement methods equivalent to all those in accordance with the first and second aspects of the invention.

Both the aspects of the present invention implement effective techniques detecting exploits by looking for hidden foreign objects inside document objects. The techniques are especially good at tackling what is currently the most common problem, namely exploits employing program files in the PE format within Microsoft Office documents, but the present invention is not limited to that combination of objects.

In general the invention may be applied to any type of electronic object which may contain exploits. This includes without limitation all documents in a file format allowing them to be rendered by an application program. The ones most likely to be exploited are ones where the rendering program is complex and contains a large amount of code; historically these types of programs have been found to contain many errors (bugs) which can be exploited. The attacker will also prefer document formats which are commonly used. This will make it likely that the victim will be used to opening that type of document, and will have the right software to open it. It will also mean that the research involved in finding an exploit can be used to attack a large base of victims. Some common examples of such applications include: Microsoft Office, Adobe Postscript, Notepad, audio and video applications, such as AVI and WMF.

The present invention is particularly suitable for application to electronic objects transferred over a network, including but not limited to electronic objects contained in emails for example transmitted using SMTP, and objects transferred using HTTP, FTP, IM (Instant Messenger), or other protocols. In this case the invention may be implemented at the node of a network to scan traffic passing therethrough. However the present invention is not limited to such situations. Another situation where it may be implemented is in the scanning of files in a file system.

To allow better understanding, an embodiment of the present invention will now be described by way of non-limitative example with reference to the accompanying drawings, in which:

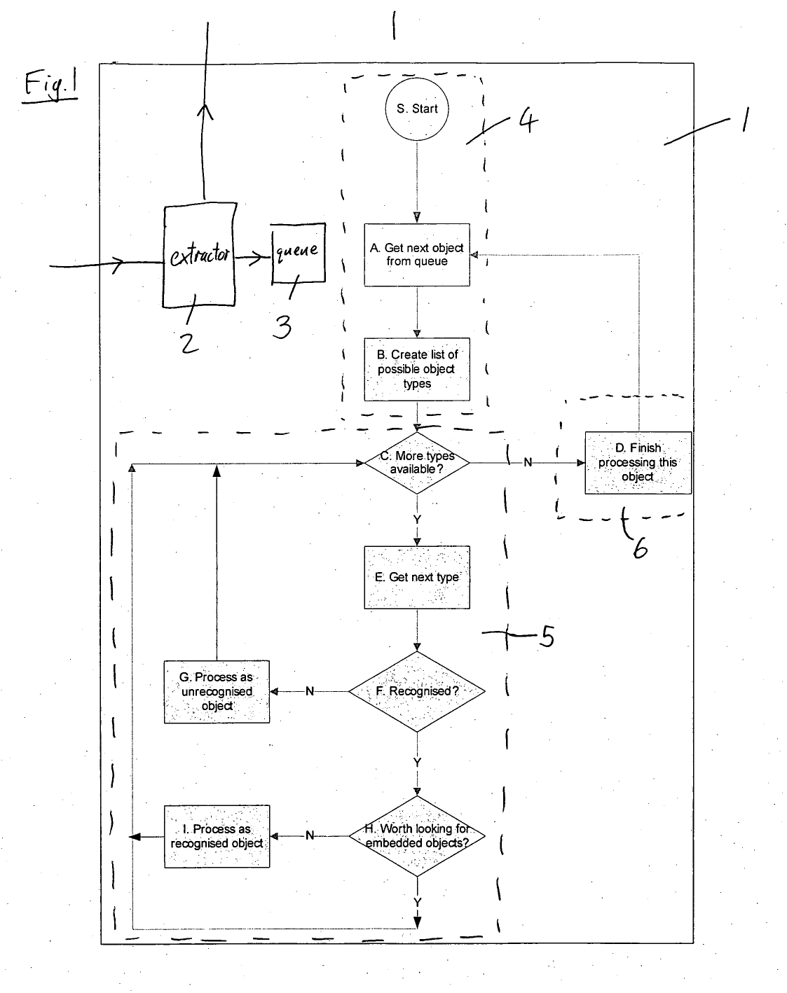

FIG. 1 is a diagram of a scanning system for scanning messages passing through a network;

FIG. 2 is a partial hex dump of a typical executable file in the PE format;

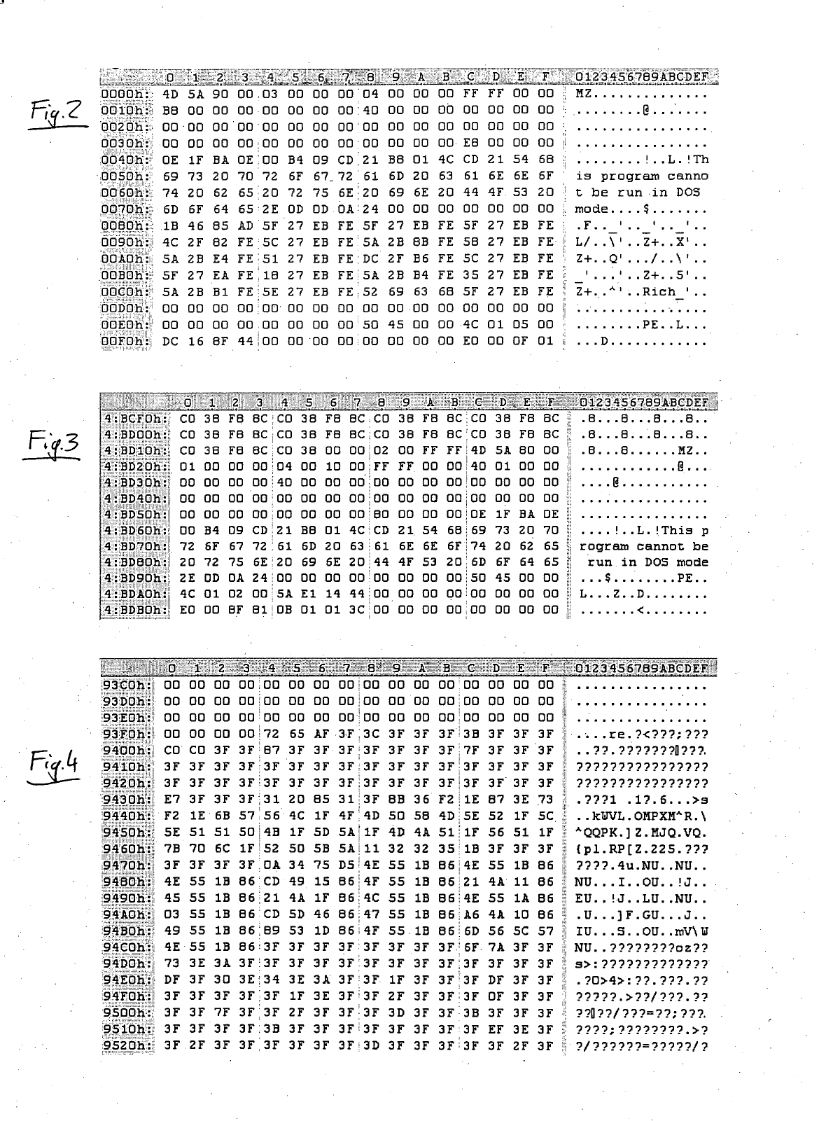

FIG. 3 is a partial hex dump of an example of a PowerPoint file having embedded therein a malicious PE Exe file;

FIG. 4 is a partial hex dump of an example of a PowerPoint file having embedded therein a malicious PE Exe file which is in XOR-encoded form;

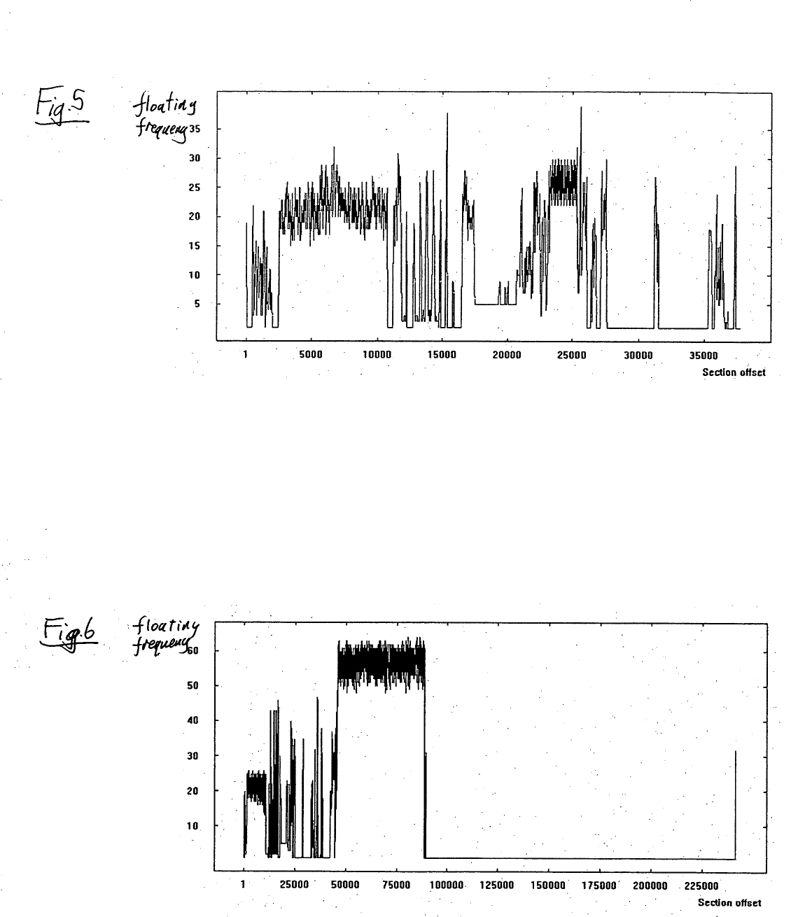

FIG. 5 is a graph of the distribution of floating frequency across a Microsoft Word document which just contains formatted text using the English language; and

FIG. 6 is a graph of a Microsoft Word document which has a malicious program embedded inside.

A scanning system 1 for scanning messages passing through a network is shown in FIG. 1. The messages may be emails, for example transmitted using SMTP or may be messages transmitted using other protocols such as FTP, HTTP, IM and the like. The scanning system 1 scans the messages for electronic objects, in particular files, to detect malicious programs hidden in the files. The scanning system 1 is provided at a node of a network and the messages are routed through the scanning system 1 as they are transferred through the node en route from a source to a destination. In such a situation, the numbers of such electronic objects needing analysis are vast and the speed and processing required to perform the analysis is very important because the time and processing power available to the scanning is limited by practical considerations. The scanning system 1 may be part of a larger system which also implements other scanning functions such as scanning for viruses using signature-based detection and/or scanning for spam emails.

However, although this application is described for illustrative purposes, the scanning system 1 could equally be applied to any situation where undesirable objects might be hidden inside other electronic objects, and where the electronic object can be assembled and presented for scanning. This could include systems such as firewalls, file system scanners and so on.

The scanning system 1 is implemented in software running on suitable computer apparatuses at the node of the network and so for convenience part of the scanning system 1 will be described with reference to a flow chart which illustrates the process performed by the scanning system 1.

The scanning system 1 has an object extractor 2 which analyses messages passing through the node to detect and extract any electronic objects, in this case files, contained within the messages. The object extractor 2 will behave appropriately according to the types of message being passed. In the case of messages which are emails, the object extractor 2 extracts files attached to the emails. In the case of HTTP traffic, the objects will typically be web pages, web page components and downloaded files. For FTP traffic, the objects will be the files being uploaded or downloaded. For IM traffic, the objects will being a file that is transferred via IM. The message may need processing to extract the underlying object. For instance, with both SMTP and HTTP the object may be MIME-encoded, and the MIME format will therefore need parsing to extract the underlying object. The extracted electronic objects are stored in a queue 3 until they can be processed.

The scanning system 1 has an object recogniser 4 which operates as follows. The object recogniser 4 starts in step S, and waits until an object is available for scanning in the queue 3.

In step A, when the object recogniser 4 is able to process another object, it takes the next available item from the queue 3.

In step B, the object recogniser 4 analyses the object to determine whether it is likely to be of any known type from a set of known types of electronic object. The known types in the set may include documents of respective file formats allowing them to be rendered by respective application programs. There is created a list of potential object types for the object under examination. If the object type is recognised, the list may include one or plural types. If the object type is unrecognised, the list has a single entry indicating an unrecognised object type.

The object recogniser 4 may recognise the object type using the following techniques.

One technique for determining the object type is to read the first few bytes of an object, and search for certain patterns of bytes, that is so-called “magic numbers”, which are always present at certain offsets, usually right at the beginning of the object. The magic numbers may be specific to the file format of the application program used to render the object. Different magic numbers are stored and checked for respective known types of the set of known types. For instance, GIF picture objects start with the three characters ‘GIF’. DOS Exe objects start with the two bytes ‘MZ’. OLE objects start with the hex bytes 0×D0×CF. In other cases, the magic bytes are not present at the start of the file. TAR objects have 257 bytes and then the sequence ‘ustar’. Yet other objects have a sequence of magic bytes, but not at any fixed offset in the file. For instance, Adobe PDF objects usually start with the sequence ‘%PDF’, but it is not actually necessary for this sequence to be right at the start of the object. The object is scanned for the magic numbers of each of the known types in the set. Location of the magic numbers indicates a likelihood that the object is of the respective known type.

Ideally, the magic numbers of all of the known types in the set should be checked.

Once the magic numbers for a given known type have been found, the object recogniser 4 may, for certain known types, perform some extra checks using additional known structural features to verify the object really is of the suspected type. For instance, an object starting ‘BM’ might be a picture object using the BMP format, or a text document discussing BMW cars. Analysis of the next few bytes should be able to at least confirm or deny with high probability whether the object is one or the other.

When the scanning system 1 is part of a larger system such as an SMTP scanner or a file system scanner, the object may have one or more associated names, such as a filename. In other embodiments, the object will be anonymous. Where file names are available, these may also be analysed to determine possible object types. In most cases, this is done by examining the characters after the last period (the extension), and ignoring any case or modifiers, such as accents. For instance, an extension of ‘EXE’ could indicate the object could be either a DOS EXE or a PE EXE. An extension of ‘doc’ could indicate the object is a Microsoft Word document.

When the system is part of a larger system such as an SMTP scanner or a HTTP scanner, the object may have an associated type, such as a MIME type. When such information is available, this should also be used to determine possible object types. For instance, a MIME type of text/html indicates the object is possibly an HTML document.

Ideally all these strategies may be used in combination to build the list of potential object types.

When the techniques indicate different potential object types the object recogniser 4 includes all the potential object types in the list. This has the effect that the object analyser 5 described further below processes the object repeatedly in respect of each potential type. This will prevent a malicious attacker exploiting the scanning system 1 by crafting an object which can be interpreted in multiple ways. If the attacker were to craft such an object, and the scanning system 1 were to only analyse it in one way, then they can put malicious behaviour in another type of object, potentially bypassing the checks. For instance, the tar archive format has its magic number several bytes within an object, whereas the JPEG picture format has its magic number right at the beginning. It may therefore be possible to craft an object which could be interpreted both as a JPEG picture and a GZ archive. Any name associated with the object may specify a third object type, and a MIME type could specify a fourth. In the scanning system 1, the object will be analysed repeatedly on the basis that it is each successive one of the four types.

The object recogniser 4 may also indicate ambiguous types as being of plural different types. For instance, a document starting with the magic number PK may be a ZIP archive, but it could also be a Java JAR or a Microsoft Office document, because both of these are built on top of the ZIP format. Similarly, a Microsoft OLE document may be a Microsoft Word, Microsoft PowerPoint, or one of many other formats which build on the OLE structures. Further analysis may be necessary to determine which if any of these formats are possible and/or need to be discriminated between. For instance, it may be decided that all OLE documents may be processed in the same way, even though they may actually be different documents, such as Word and PowerPoint.

The list of potential object types created by the object recogniser 4 is supplied to an object analyser 5 which analyses the object as follows.

The object analyser 5 considers each of the potential object types in the list. In particular, in step C, the object analyser 5 determines whether any of the object types in the list remain available for consideration. If so, one of the remaining types is selected in step E.

In step F it is determined whether the selected type indicates that the object is unrecognised. If so, the object analyser 5 processes the object as an unrecognised object in step G.

Otherwise, if it is determined in step F that the object type is a recognised one, in step H it is determined whether the object type is one for which it is worthwhile analysing for malicious programs. This is determined on the basis of the object type. For most object types, the scan is worthwhile and so the object analyser 5 processes the object as a recognised object in step I. However for a few object types no scan is worthwhile and the object analyser 5 reverts to step C. This reduces the time and processing power required by the scanning system 1 for the scanning.

The processing of the object in step G or step I is described in detail below. After processing of the object in step G or step I, the object analyser 5 reverts to step C.

When it is determined in step C that all the object types have been considered the object analyser 5 proceeds to step D in which a remedial action unit 6 takes any necessary remedial action as described further below. Then the scanning system 1 reverts to step A.

Although the scanning system 1 is described with reference to a serial decision flow in FIG. 1, of course the various processes may alternatively be performed in parallel. For example, the object recogniser 4 and the object analyser 5 may operate in parallel. Similarly the analysis of the different object types by the object analyser 5 may be performed in parallel.

The analysis of the objects performed in steps G and I will now be described in detail. In general, the objects are searched for malicious programs using various different techniques. Also, particular search algorithms may depend on the processing power of the scanning system 1. This allows the scanning system 1 to be adapted to the amount of time and processing power available for practical reasons. If the scanning system 1 is part of a larger message passing system, such as a SMTP or HTTP scanner, the search algorithms may also depend on options selected by the message sender or recipient.

For objects of recognised types, the analysis techniques applied in step I are as follows. The techniques, which may be used in any order and in any combination, are:

(a) scanning the object for program files of specific formats;

(b) scanning the object for encoded program files of specific formats, using various encoding strategies;

(c) searching the object for unknown foreign objects using statistical fingerprinting techniques; and

(d) searching the object for program files of specific formats using statistical fingerprinting techniques.

The techniques (a) to (d) are described in more detail below.

In techniques (a), (b) and (c), optionally the object analyser 5 is responsive to the type of the electronic object to analyse the electronic object and to identify particular parts of the electronic object in accordance with its type. In this case the analysis is applied to only those particular parts of the object. This has the advantage of speeding up the analysis process by not considering those parts which are not considered likely to contain a malicious program. However this is not essential. For some or all types of object, the entire object may be analysed. The object is optionally searched for specific foreign objects using statistical fingerprinting techniques.

For objects of unrecognised types, the analysis techniques applied in step G are techniques (a), (b) and (d) set out above. The techniques may be used in any order and in any combination. As the type of the object is not known, the techniques (a), (b) and (d) are applied to the entire object, not just particular parts. Technique (c) is not applied because as described below it relies on knowledge of the object type.

Technique (a) of scanning the object for program files of specific formats is performed as follows.

Technique (a) is based on the principles that a program file hidden in the object is likely to be malicious. Therefore technique (a) involves scanning the object to detect such a program file. In particular technique (a) involves scanning the file for a pattern of bytes in respect of a particular format of program file. The pattern of bytes is characteristic of a particular format in the sense that it is always or predominantly present in a file of a specific format. The pattern of bytes may be identified for use by the object analyser 5 by considering the published specification for the format in question. Detection of the pattern of bytes indicates a high probability of a program file in that format being present in the electronic object. This is taken to indicate that there is a likelihood of the electronic document containing an exploit and the object analyser 5 outputs a signal indicating this. The signal may for example be output by setting a flag in respect of the object.

Technique (a) may be implemented in respect of a plurality of patterns of data in respect of all file formats of program files which are considered likely to pose a risk of being used as an exploit. One type of file format which may be used is the PE format, but other file formats may be used for example the ELF format.

An example of a scanning strategy for finding files of the PE format is as follows.

The PE Exe file format has been extensively documented. From that documentation one can identify the following information. PE Exe files start with the byte sequence 0×4D, 0×5A (MZ in ASCII). At offset 0×3C in the file are 4 bytes stored in little-endian format which are an offset from the MZ bytes to the byte sequence 0×50, 0×45, 0×00, 0×00. This is the pattern of bytes used to detect an file of the PE format. This is shown for example in FIG. 2 which is a hex dump of a typical PE Exe file.

FIG. 3 shows an example of a malicious PowerPoint file with an embedded PE Exe file. During scanning of the file, at offset 0×4BD1C the object analyser 5 finds the 0×4D, 0×5A sequence. 0×3C bytes later the object analyser 5 finds the bytes 0×80, 0×00, 0×00, 0×00, which are little endian for 0×00000080. Offset 0×00000080 from 0×4BD1C takes us to 0×4BD9C, where the object analyser 5 finds the bytes 0×50, 0×45, 0×00, 0×00. Thus, the object analyser 5 finds the pattern of bytes for a PE Exe file, starting at offset 0×4BD1C. This is taken to indicate a likelihood that such a PE Exe file is embedded and hence that the PowerPoint file contains a malicious program.

Of course the technique is probabilistic in the sense that there remains a chance of a false positive in the event that a given object contains the pattern of bytes by chance. The false positive rate is controlled by choice of the pattern of bytes. For example an alternative pattern of bytes for a PE Exe file would be a 0×4D byte followed by a 0×5A byte. This would definitely find all objects which contained embedded PE files. However, it would likely find many such sequences which are not actually PE Exe files. In a random data stream, every time we find an 0×4D byte, we would expect the next byte to be 0×5A in one time in 256 as each byte has 256 different possible values. This could result in a false detection.

The chances of false detection are made less likely by extending the pattern of data which is detected. For instance, having found a 0×4D, 0×5A sequence, we can then use the data stored at offset 0×3C from this sequence as a little-endian offset from the 0×4D, 0×5A sequence to check for the byte sequence 0×50, 0×45, 0×00, 0×00. Adding such extra information in the pattern of bytes does not mean we will miss any embedded PE Exe files, and improves our chances of not having a false detection. Assuming a random data stream, the extra pattern improves the chances of false detection whenever we find a 0×4D, 0×5A sequence from 1 in 256 to better than 1 in 2565. The reason that the chances are better than this is that certain values of the offset will also be invalid and point to an area lying outside the object being examined. Of course the pattern of bytes could be extended further to further check the integrity of the supposed embedded PE Exe file until the probability of false detection is as low as desired, although of course any extension slows the scanning process.

As discussed above, the scanning technique (a) can be improved by only scanning particular parts of the objects in which it is possible to embed a foreign object. In accordance with the object type, the object is parsed and the particular parts are selected. For instance, in the case of a Microsoft Office document, the first 8 bytes are required to be 0×D0, 0×CF, 0×11, 0×E0, 0×A1, 0×B1, 0×1A, 0×E1 and if they are not then they will not be processed by Office, and there is no possibility of an exploit. In this case, scanning for foreign objects can safely start following these 8 bytes.

Technique (b) of scanning the object for encoded program files of specific formats is performed as follows.

Technique (b) is the same as technique (a) except that the object analyser 5 scans the object for the pattern of bytes in one or more encoded forms. Thus technique (b) applies some form of cryptographic attack to detect encoded program files. The reason is that the attacker will sometimes encode an exploit before embedding it. If the attacker commonly uses the same form of encoding, and this encoding scheme is susceptible to cryptographic attack then the scan routine can be adapted to do additional checks for encoded objects.

The exact decision as to whether an encoding scheme is susceptible to cryptographic attack will depend on the current state of the art of cryptography, the computing power available to the decoding party, and the time available for decoding. For instance a system analysing objects in an SMTP stream may be able to attempt to break more encoding schemes than an analyser in an HTTP stream, because typically people are more tolerant of delays in email than delays in web browsing.

By way of example one weak encoding scheme often used by attackers is XOR encoding with a one-byte key. This can broken using the following simple scanning strategy. An XOR operation with one of the bytes of the pattern of bytes is performed on each byte in the file to obtain a potential key K. Then an XOR operation using the potential key K is performed to detect the remainder of the pattern of bytes. For example in the case of the pattern of bytes for a PE file discussed above with reference to technique (a) this strategy involves the steps:
(1) for each byte B1 in the file, XOR with 0×4D (M) to obtain a potential key K1;
(2) XOR the next byte, B2 with K1. If the value is 0×5A (Z), then we may have found a PE Exe file encoded using XOR encoding with key K1 ;
(3) as before, the likelihood of false positives can be decreased by extending the pattern - for example, decode the 4 bytes at offset 0×3C from B1 by XORing using key K1, giving a new offset from B1 in little endian format, and then decode the 4 bytes at this offset by XORing using key K1, and if this results in the sequence 0×50, 0×45, 0×00, 0×00 then the likelihood of this being an encoded PE file increases.

Such an algorithm will also find unencoded PE Exe files, and when this occurs the value of K1 will be 0×00. This may be important if it is necessary to distinguish finding an encoded PE Exe file from an unencoded PE Exe file.

By way of example FIG. 4 shows part of a Microsoft Word document which contains an embedded PE Exe file encoded with XOR encoding. The above search strategy will find this embedded file as follows. The bytes from 0×0000 to 0×93f3 are examined using the algorithm, but no possible embedded PE Exe file is found. Next:
(1) the byte B1 at offset 0×93f4 is 0×72, and when this is XORed with 0×4D, this results in a potential key K1 of 0×3F;
(2) The next byte, B2 is XORed with K1 producing 0×5A—the object analyser 5 may therefore have found a potential key;
(3) the offset 0×3C from B1 is 0×9430 and the 4 bytes at this location are 0×E7, 0×3F, 0×3F, 0×3F—when XORed with K1 this becomes 0×D8, 0×00, 0×00, 0×00, or in little-endian format, 0×000000D8.
(4) the offset 0×000000D8 from B1 is 0×94CC and the 4 bytes at this location are 0×6F, 0×7A, 0×3F, 0×3F—when XORed with K1 this becomes 0×50, 0×45, 0×00, 0×00, suggesting that this is an embedded PE Exe file, encoded using XOR encoding with a key of 0×3F.

Techniques (c) and (d) both apply statistical fingerprinting. Techniques (a) and (b) fail if the attacker uses an exploit with an embedded file of a format not covered by the scanning system 1 or if the attacker uses an encoding scheme not tackled by the scanning system 1 in the application of technique (b). Techniques (c) and (d) can detect exploits in these circumstances.

Techniques (c) and (d) make use of a database of fingerprints. The fingerprints are each of a typical file of a specific type. The fingerprints represent the distribution of a statistical measure across at least part of an electronic object, or often an entire electronic object.

The statistical measure is chosen to allow recognition of different types of files. In the present case, the statistical measure is a measure of the degree of variation in the data values of the electronic object within a region of the electronic object. One simple example of such a statistical measure is the number of different data values within a region of a predetermined size, typically in the range of 10 to 256 bytes, for example 64 bytes. This statistical measure is referred to as a floating frequency and is easy to derive as it simple involves counting the number of data values in the region - if every byte in the region is the same, the count will be one whereas the maximum count, if all bytes are different, will be the size (number of bytes) of the region.

The floating frequency or other statistical measure may be derived for each consecutive region to derive the distribution.

A statistical measure which measures the degree of variation in the data values of the electronic object within a region is useful in the present context because it allows a document which is intended to be rendered by an application program to be distinguished from an executable program, because a document and a executable program will typically have different distributions of the statistical measure. For example a document, particularly a text document representing alphanumeric text, will typically have relatively low values of the statistical measure for large parts, whereas an executable program will have relatively high values of the statistical measure.

By way of example, FIG. 5 is a graph of the distribution of floating frequency across a Microsoft Word document which just contains formatted text using the English language (and no drawings or other such items) and FIG. 6 is a graph of a Word document which has a malicious program embedded inside. It can be seen from FIG. 5 that the normal Microsoft Word document has a low floating frequency, usually under 30 different data values per 64 byte region. In contrast it can be seen from FIG. 6 that the Word document which has a malicious object hidden inside has a large area with a high floating frequency, generally between 50 and 60, occurring from before offset 50000 to after offset 75000. This type of area does not match our expected fingerprint for Word documents, and so allows the document to be distinguished from a normal, safe Word document.

Technique (c) of searching the object for unknown foreign objects using statistical fingerprinting techniques is performed as follows.

Technique (c) makes use of a database of fingerprints in respect of typical objects of the set of known types of object which are recognised by the object recogniser 4. The object analyser 5 derives a distribution of the statistical measure in respect of the object under examination. Then the object analyser 5 compares the derived distribution with the fingerprint contained in the database in respect of the type of object currently under consideration by the object analyser 5. Based on this comparison, the object analyser 5 determines if the actual fingerprint derived for the object matches the fingerprint in the database. If there is a match, the object has an expected distribution for that type of object and is not suspicious. However, if there fails to be a match, the object has an unexpected distribution for that type of object. This is taken to indicate that there is a likelihood of the electronic object containing an exploit, and the object analyser 5 outputs a signal indicating this. The signal may for example be output by setting a flag in respect of the object.

The conditions for matching are set using statistical principles to allow distinction between typical objects of the type in question and objects containing a malicious program. Thus a match is achieved for a range of distributions similar to the stored fingerprint. A failure condition occurs if any part of the object does not match the fingerprint. The detection rate and false positive rate may be varied by changing the match conditions for a given fingerprint. Some examples of fingerprints, are:
(i) 95% of the object has a floating frequency value below 30; or
(ii) there are no contiguous regions of size greater than 200 bytes where the floating frequency value is greater than 30.

It is also possible for a fingerprint to consist of a number of rules, which may be combined in different ways. For instance, one requirement may be that all rules are satisfied. Another that at least an amount X of a set of Y rules are satisfied.

In a modification to account for degrees of variation in a given known type of object, the database may store plural fingerprints for the known type of object and the object analyser 5 may output a signal if indicating a suspicious file if the object fails to match any of the fingerprints.

Technique (c) may be further modified as follows.

As discussed above, the technique may be improved by scanning particular parts of the objects selected in accordance with the object type. Thus it is possible to avoid scanning parts where it is deemed unlikely for an exploit to be located.

The technique can also be improved more generally by using as much knowledge as possible of the document under analysis.

For instance, Microsoft OLE documents are very much like a mini FAT filing system, and one such document may contain many streams. These streams may be scattered all over the physical file. Results will improve if the streams are logically gathered together for analysis. For instance, one stream may contain pictures, and another stream may contain text, and these streams may be physically interleaved in the document under analysis. Results will improve if all the text stream components are gathered together in sequence, and similarly for the picture stream components, since these types of streams typically have different fingerprints. Typical fingerprint rules may be something like the following:
(i) for areas identified as type X, the floating frequency value is between 10 and 20 for 99% of the area; or
(ii) for areas identified as type Y, the floating frequency value is between 15 and 40 for the first 200 bytes, between 40 and 50 for the next 50% of the area, and above 30 for 95% of the remainder.

As another example, if the document is an archive, such as a ZIP or RAR file, then we can first extract the compressed documents before analysing them. If we do this, then a further refinement would be to add protection against archive exploits, such as a small compressed file expanding to several terabytes of uncompressed file.

In case where an archive or an OLE file contains an expected embedded foreign object, this would not necessarily be considered suspicious in itself. For instance, Microsoft Word documents can contain embedded spreadsheets, pictures and even PE Exe files which have been embedded using the normal functions of Word. If such an object is detected then it is not hidden. It can be extracted using normal techniques, and analysed for malware using further heuristic and signature based-techniques. The scanning system 1 can also be configured to treat these types of objects as suspicious on a per recipient basis, and also by considering what type of foreign object is embedded in what type of containing object, and also in which structural part of the containing object it is found. For instance, a PE Exe object found where a PE Exe object might normally be, is less suspicious than a PE Exe object found where a picture might normally be.

In some cases, enough might be known about the structure of a document to be able to eliminate certain areas from the fingerprinting. For instance, a Microsoft Word document might contain an embedded picture, and performing a fingerprint analysis on the whole document might suggest that the picture is suspicious. However, if we know from the structure of the document that the suspicious area is actually a picture, and we are able to validate that it has the correct format for a picture we can eliminate that part of the document from the fingerprinting process, and just search the remainder of the document.

Technique (c) works well as long as the type of object to be analysed can be determined, and a statistical technique which creates a fingerprint for the type of document under analysis can be identified. Sometimes this is not possible, and for this reason technique (d) of searching the object for program files of specific formats using statistical fingerprinting techniques is applied. Technique (d) turns the problem on its head by creating a fingerprint of the thing being sought and is performed as follows.

Technique (d) makes use of a database of fingerprints in respect of typical program files of known formats. Technique (d) is based on the principle that a program file hidden in the object is likely to be malicious. Therefore technique (d) involves detecting such a program file. The technique may be implemented in respect all file formats of program files which are considered likely to pose a risk of being used as an exploit. One type of file format which may be used is the PE format, but other file formats may be used for example the ELF format.

The object analyser 5 derives a distribution of the statistical measure in respect of the object under examination. Then the object analyser 5 compares the derived distribution with all the fingerprints contained in the database. Based on this comparison, the object analyser 5 determines if the actual fingerprint derived for the object matches any fingerprint in the database. If there is no match with any fingerprint, then the object is not suspicious. However, if there is a match with any fingerprint in the database, the object is considered to contain a program file of that format. This is taken to indicate that there is a likelihood of the electronic object containing an exploit, and the object analyser 5 outputs a signal indicating this. The signal may for example be output by setting a flag in respect of the object.

When technique (d) is applied in step G in respect of an object of unrecognised type then the distribution is derived for the entire object.

When technique (d) is applied in step I in respect of an object of recognised type then the distribution may be derived for the entire object or for a particular part of the object selected in accordance with the object type as discussed above.

Technique (d) may be applied only in step G that is responsive to failure to determine th object type or may be applied in both steps G and I and so be performed effectively irrespective of the object type.

Different organisations will have different approaches to risk management. Analysing files in this manner is a CPU intensive process, and takes a finite time. Adding more analysis steps will increase the time taken. In general one set of hardware will be able to process files at a certain maximum rate. If this rate is not sufficient, then one approach might be to add more hardware. Another approach might be to do less analysis. Cost conscious organisations might therefore want to be able to tailor the amount of analysis done so as to limit the amount of hardware they need to buy, whereas paranoid organisations may prefer to buy more hardware and perform all the tests.

For instance, the truly paranoid may attempt analysis both with and without pre-parsing using structural knowledge. Others may pre-parse the document and then only analyse the results.

Organisations may also want to define a minimum set of analysis routines that will always occur, but allow more analysis to occur when the hardware is not under load. This will sacrifice consistent detection, but will increase the likelihood of detecting malware.

The remedial action unit 6 is now described. The remedial action unit 6 is responsive to a signal output by the object analyser 5 that a given object is likely to contain an exploit, and in this situation takes remedial action. A wide range remedial actions are possible, for example: quarantining the object; subjecting the object to further tests; scheduling the object for examination by a researcher; scheduling the object for further automatic checks; blocking the object; informing various parties of the event either immediately, or on various schedules. Any one or combination of remedial actions may be performed.

The remedial action may be dependent on the requirements of the sender/recipient/administrator. For instance, a paranoid organisation such as the military may choose to block all suspicious objects, inform various parties, and schedule the objects for further examination. In contrast, an organisation that depends on speedy delivery of all documents to make its money might choose to block all objects where a PE file is found hidden in a Word document. However, if a Word document is detected which did not meet the expected signature using floating frequency analysis, they might choose to let it through but also schedule the file for further analysis by a researcher. Thus business as normal is expedited, but if the subsequent analysis finds something suspicious, they can quickly take action to mitigate effects, such as removing the affected computer from the network.

If the scanning system 1 is part of a larger scanner then the remedial action may also be dependent on the results of other types of scan.

The remedial action may be dependent on the type of the object and/or the technique by which the object analyser 4 determined that the object is likely to contain an exploit. For example, the remedial action may take account of the different techniques having different levels of accuracy. For instance, finding an XOR-encoded PE Exe file inside a Word document may be taken as an extremely high likelihood of malicious intent, because false detection is extremely unlikely, and the act of XOR-encoding the document is a sign that the encoder is trying to hide something, which is rarely a harmless action. Finding an unencoded PE Exe file inside a Word document may be taken as a slightly less likelihood of malicious intent (but still high). In that case, false detection is still extremely unlikely, but the fact that the PE Exe is not hidden by encoding means that there may just be a legitimate reason for it being there.

The scanning system 1 may be modified in a variety of manners. Some possible modifications are as follows.

The queuing system implemented in the queue 3 can be adapted to achieve different purposes. It may use a simple first in, first out strategy, or a more complicated system allowing objects from certain sources or to certain destinations to have higher priority. Object complexity may also be an issue. Complex objects which have a potentially high scan time can also be assigned different priorities. For instance, in a system that can process multiple queue items simultaneously, one or more of these processing paths may be dedicated to scanning simple objects, so that the whole system is never clogged up with complex objects. Priority is not necessarily static. For instance, a low priority item may have its priority raised the longer it remains queued. Alternatively, for certain uses it may make no sense to scan objects once they have been in the queue past a certain time, so they may be discarded and the object deleted.

Heuristic systems occasionally make errors, and without correction given the same set of circumstances they will make the same error every time. It is therefore advantageous to build as many hooks into the system as possible so that errors can be fixed. For instance, at the start of processing one hook could be to create one or more cryptographic hashes of the object. This can be compared to a set of known good hashes for objects which have caused trouble in the past, and these particular objects can then be ignored. Similar hooks can be built into the other decision points in the system.

The results from the analysis may be used directly, or fed as input into part of a larger heuristic scanning system.

To save processing time, once a final decision has been made it may be possible to skip further processing. For instance, for an object with two possible types, if malware is found in the first type and the system is configured to quarantine malware, then there is no point in also processing the object as the second type—the object can be quarantined immediately.

1. A method of scanning electronic objects for exploits, the method comprising:
scanning the electronic objects to detect a pattern of bytes which is characteristic of a program file of a specific format; and
responsive to detecting such a pattern of bytes in an electronic object, outputting a signal indicating that there is a likelihood of the electronic document containing an exploit.

2. A method according to claim 1, further comprising:
analysing the electronic objects to determine whether each electronic object is likely to be of any known type of a set of known types; and
responsive to determining that an electronic object is likely to be of any known type, performing said scanning of the electronic object across predetermined parts of the electronic object selected in accordance with the known type in question.

3. A method according to claim 2, further comprising, responsive to failing to determine that an electronic object is likely to be of any one of said set of known types, performing said scanning of the electronic object across the entire electronic object.

4. A method according to claim 1, wherein said step of scanning the electronic objects is performed to detect said pattern of bytes in an unencoded form and to detect said pattern of bytes in at least one encoded form.

5. A method according to claim 4, wherein said at least one encoded form includes an XOR-encoded form.

6. A method according to claim 1, wherein said step of scanning the electronic objects is performed to detect a plurality of patterns of bytes which are each characteristic of a program file of a respective format.

7. A scanning system for scanning electronic objects for exploits, the system comprising an object analyser operative to scan the electronic objects to detect a pattern of bytes which is characteristic of a program file of a specific format, the object analyser being operative, responsive to detecting such a pattern of bytes in an electronic object, to output a signal indicating that there is a likelihood of the electronic document containing an exploit.

8. A scanning system according to claim 7, further comprising an object recogniser operative to analyse the electronic objects to determine whether each electronic object is likely to be of any known type of a set of known types,
the object analyser being responsive to the object recogniser determining that an electronic object is likely to be of a known type by performing said scanning of the electronic object across predetermined parts of the electronic object selected in accordance with the known type in question.

9. A scanning system according to claim 8, wherein the object analyser is responsive to the object recogniser failing to determine that an electronic object is likely to be of any one of said set of known types by performing said scanning of the electronic object across the entire electronic object.

10. A scanning system according to claim 7, wherein said step of scanning the electronic objects is performed to detect said pattern of bytes in an unencoded form and to detect said pattern of bytes in at least one encoded form.

11. A scanning system according to claim 10, wherein said at least one encoded form includes an XOR-encoded form.

12. A scanning system according to claim 7, wherein the object analyser is operative to scan the electronic objects to detect any of a plurality of patterns of bytes which are each characteristic of a program file of a respective format.

13. A method of scanning electronic objects for exploits, the method comprising the following steps performed in respect of individual electronic objects:
analysing the electronic objects to determine whether each electronic object is likely to be of a known type of a set of known types;
responsive to determining that an electronic object is likely to be of a known type:
(a) deriving a distribution, across at least part of the electronic object, of a statistical measure which is a measure of the degree of variation in the data values of the electronic object within a region of the electronic object;
(b) extracting at least one fingerprint in respect of the known type from a database of fingerprints which represent distributions of said statistical measure in respect of the known types of said set of known types of electronic object;
(c) determining whether the derived distribution fails to match the at least one extracted fingerprint; and
(d) responsive to a determination that the derived distribution fails to match the extracted fingerprint, outputting a signal indicating that there is a likelihood of the electronic document containing an exploit.

14. A method according to claim 13, wherein said distribution is derived across predetermined parts of the electronic object selected in accordance with the known type in question.

15. A method according to claim 13, further comprising:
responsive to failing to determine that an electronic object is likely to be of any one of said set of known types:
(a) deriving a distribution, across the entire the electronic object, of a statistical measure which is a measure of the degree of variation in the data values of the electronic object within a region of the electronic object;
(b) detecting whether the derived distribution, in any part, matches any fingerprint in a database of fingerprints which each represent a distribution of said statistical measure in respect of a program file of a specific format; and
(c) responsive to detecting that the derived distribution matches a fingerprint in the database, outputting a signal indicating that there is a likelihood of the electronic document containing an exploit.

16. A method according to claim 13, further comprising, irrespective of determining or failing to determine that an electronic object is likely to be of any one of said set of known types:
(a) deriving a distribution, across at least part of the electronic object, of a statistical measure which is a measure of the degree of variation in the data values of the electronic object within a region of the electronic object;
(b) detecting whether the derived distribution, in any part, matches any fingerprint in a database of fingerprints which each represent a distribution of said statistical measure in respect of a program file of a specific format; and
(c) responsive to detecting that the derived distribution matches a fingerprint in the database, outputting a signal indicating that there is a likelihood of the electronic document containing an exploit.

17. A method according to claim 13, wherein the statistical measure is the number of data values in a region of predetermined size.

18. A method according to claim 17, wherein the predetermined size is in the range from 10 to 256 bytes.

19. A method of scanning electronic objects for exploits, the method comprising the following steps performed in respect of individual electronic objects:
deriving a distribution, across at least part of the electronic object, of a statistical measure which is a measure of the degree of variation in the data values of the electronic object within a region of the electronic object;
detecting whether the derived distribution, in any part, matches any fingerprint in a database of fingerprints which each represent a distribution of said statistical measure in respect of a program file of a specific format; and
responsive to detecting that the derived distribution matches a fingerprint in the database, outputting a signal indicating that there is a likelihood of the electronic document containing an exploit.

20. A method according to claim 19, further comprising:
analysing the electronic objects to determine whether each electronic object is likely to be of any known type of a set of known types; and
responsive to determining that an electronic object is likely to be of any known type, deriving said distribution across predetermined parts of the electronic object selected in accordance with the known type in question.

21. A method according to claim 20, further comprising, responsive to failing to determine that an electronic object is likely to be of any one of said set of known types, deriving said distribution across the entire electronic object.

22. A method according to claim 19, wherein the statistical measure is the number of data values in a region of predetermined size.

23. A method according to claim 22, wherein the predetermined size is in the range from 10 to 256 bytes.

24. A scanning system for scanning electronic objects for exploits, the system comprising:
an object recogniser operative to analyse the electronic objects to determine whether each electronic object is likely to be of a known type of a set of known types; and
an object analyser which is operative, responsive to determining that an electronic object is likely to be of a known type:
(a) to derive a distribution, across at least part of the electronic object, of a statistical measure which is a measure of the degree of variation in the data values of the electronic object within a region of the electronic object;
(b) to extract at least one fingerprint in respect of the known type from a database of fingerprints which represent distributions of said statistical measure in respect of the known types of said set of known types of electronic object;
(c) to determine whether the derived distribution fails to match the at least one extracted fingerprint; and
(d) responsive to a determination that the derived distribution fails to match the extracted fingerprint, to output a signal indicating that there is a likelihood of the electronic document containing an exploit.

25. A method according to claim 24, wherein said object analyser is operative to derive a distribution across predetermined parts of the electronic object selected in accordance with the known type in question.

26. A method according to claim 24, wherein said object analyser is further operative, responsive to failing to determine that an electronic object is likely to be of any one of said set of known types:
(a) to derive a distribution, across the entire the electronic object, of a statistical measure which is a measure of the degree of variation in the data values of the electronic object within a region of the electronic object;
(b) to detect whether the derived distribution, in any part, matches any fingerprint in a database of fingerprints which each represent a distribution of said statistical measure in respect of a program file of a specific format; and
(c) responsive to detecting that the derived distribution matches a fingerprint in the database, to output a signal indicating that there is a likelihood of the electronic document containing an exploit.

27. A method according to claim 24, wherein said object analyser is further operative, irrespective of determining or failing to determine that an electronic object is likely to be of any one of said set of known types:
(a) to derive a distribution, across at least part of the electronic object, of a statistical measure which is a measure of the degree of variation in the data values of the electronic object within a region of the electronic object;
(b) to detect whether the derived distribution, in any part, matches any fingerprint in a database of fingerprints which each represent a distribution of said statistical measure in respect of a program file of a specific format; and
(c) responsive to detecting that the derived distribution matches a fingerprint in the database, to output a signal indicating that there is a likelihood of the electronic document containing an exploit.

28. A scanning system according to claim 24, wherein the statistical measure is the number of data values in a region of predetermined size.

29. A scanning system according to claim 28, wherein the predetermined size is in the range from 10 to 256 bytes.

30. A scanning system for scanning electronic objects for exploits, the system comprising:
an object analyser which is operative:
to derive a distribution, across at least part of the electronic object, of a statistical measure which is a measure of the degree of variation in the data values of the electronic object within a region of the electronic object;
to detect whether the derived distribution, in any part, matches any fingerprint in a database of fingerprints which each represent a distribution of said statistical measure in respect of a program file of a specific format; and
responsive to detecting that the derived distribution matches a fingerprint in the database, to output a signal indicating that there is a likelihood of the electronic document containing an exploit.

31. A scanning system according to claim 30, wherein
said scanning system further comprises an object analyser operative to analyse the electronic objects to determine whether each electronic object is likely to be of any known type of a set of known types; and
said object analyser is operative, responsive to determining that an electronic object is likely to be of any known type, to derive said distribution across predetermined parts of the electronic object selected in accordance with the known type in question.

32. A scanning system according to claim 31, said object analyser is operative, responsive to failing to determine that an electronic object is likely to be of any one of said set of known types, to derive said distribution across the entire electronic object.

33. A scanning system according to claim 30, wherein the statistical measure is the number of data values in a region of predetermined size.

34. A scanning system according to claim 33, wherein the predetermined size is in the range from 10 to 256 bytes.

35. A method according to claim 1 further comprising, responsive to a signal indicating that there is a likelihood of an electronic document containing an exploit, performing a remedial action.

36. A method according to claim 1, wherein the electronic objects are files.

37. A method according to claim 36, wherein the electronic objects are documents in a file format allowing them to be rendered by an application program.

38. A method according to claim 1, wherein the electronic objects are contained in data being transferred over a network.

39. A method according to claim 38, wherein the electronic objects are contained in any one or more of emails, HTTP traffic, FTP traffic, and IM traffic.

40. A method according to claim 38, wherein the electronic objects are passing through a node of a network.

41. A scanning system according to claim 7, further comprising a remedial action unit which is operative, responsive to a signal indicating that there is a likelihood of an electronic document containing an exploit, to perform a remedial action.

42. A scanning system according to claim 7, wherein the electronic objects are files.

43. A scanning system according to claim 42, wherein the electronic objects are documents in a file format allowing them to be rendered by an application program.

44. A scanning system according to claim 7, wherein the electronic objects are contained in data being transferred over a network.

45. A scanning system according to claim 44, wherein the electronic objects are contained in any one or more of emails, HTTP traffic, FTP traffic, and IM traffic.

46. A scanning system according to claim 43, wherein the electronic objects are passing through a node of a network.
